(19) United States
(12) Patent Application Publication
(10) Pub. No.: US 2002/0157507 A1
(43) Pub. Date: Oct. 31, 2002

(54) Automatic and variable grip locking pliers

(76) Inventor: Wayne W. Chou, Ridgefield, CT (US)

Correspondence Address: Connolly Bove Lodge & Hutz LLP, Suite 800, 1990 M Street, N.W., Washington, DC, 20036-3425, US

(21) Appl. No.: 09/843,798

(22) Filed: Apr. 30, 2001

(51) Int. Cl. B25B 7/12

(52) U.S. Cl. 81/367

(57) ABSTRACT

A self adjusting grasping pliers. Upper and lower grasping jaws are pivotally connected together. A first handle extends rearward from the upper grasping jaw, and a second handle pivotally connected to the lower grasping jaw extends rearward thereof. A toggle member connects to one end of the second handle extending upwards into the longitudinal slot of the first handle. A pressure adjustment control is connected to one end of the handle, and extends into the handle a distance which is adjustable. A grasping size control rod extends through the pressure adjustment control engaging one end of the toggle member. A spring is located between a stop fixed threaded to the control rod and the pressure adjustment control. The pressure control is adjusted to establish a nominal grasping force. During grasping of an object, the control rod can move against the force of the spring limiting the force exerted on an object between the jaws.

### FIELD OF THE INVENTION

The present invention is directed to a type of handtool. Specifically, a type of locking pliers is disclosed which provides with a single setting a range of grasping sizes.

Patent literature describes numerous types of handtools which may be used for grasping objects of both a uniform and irregular shape. One class of such handtools is a locking type pliers having a set of grasping jaws which can be set to a predetermined grasping dimension. The pliers, when engaging an object, are locked to the object as the grasping distance is fixed in size. The grasping force is a function of the difference in size between the object and the space between the jaws, i.e., the grasping distance.

The locking pliers include a control for adjusting the grasping distance to accommodate different object dimensions. The grasping distance is changed by moving the pivot point of the handles on the pliers. Each time a different sized object is to be grasped, the grasping jaws must be spaced to lock the pliers on the object.

While locking pliers have the advantage of maintaining their grasp on an object, each setting is limited to a specific object size. In the event that there is any significant mismatch between the dimension of the article being grasped and the grasping distance of the locking pliers, the pliers may place an exceedingly large force on the object when it is grasped. The result of the excessive force on the object, in the case of wood or other deformable material, is an objectionable compression of the material. In other cases, where the grasping distance of the jaws was set too small with respect to the object being grasped, a large force may be necessary to break the locking grasp between the pliers and the object. These problems are only avoided by a meticulous trial and error of the plier's adjustment screw until the operator finds an acceptable setting for the grasping distance of the jaws.

### SUMMARY OF THE INVENTION

The present invention provides for a self-adjusting grasping pliers which can be used to grasp a set of objects having a range of dimensions. The grasping pliers accommodate a range of object dimensions with a single setting to avoid the consequence of an excessive force being applied to an object being grasped.

In carrying out the invention, a lower grasping jaw is pivotally connected to an upper grasping jaw. First and second handles extend from, respectively, the upper grasping jaw, and the lower grasping jaw rearward thereof. The jaws are biased together by a spring urging them in an open position. A toggle member is connected pivotally at one end to the second handle and extends upward into a longitudinal slot in the first handle. A control rod extends through the first handle and has one end which engages the toggle member. The control rod includes a stop which bears against one end of a spring extending rearward towards the first handle rearward end. The distance between the jaws is adjusted by rotating the protruding end of the control rod threading it into or out of the stop, thereby positioning the toggle member. A nominal grasping range is established which can increase from a nominal setting set by the control rod as the control rod moves rearward against the force of the spring during grasping. A pressure adjustment control bears against the remaining end of the spring to adjust the amount of compression of the spring thereby establishing a nominal grasping force for the jaws.

### DESCRIPTION OF THE DRAWINGS

FIG. 1 is a plan view of the self-adjusting grasping pliers in accordance with the preferred embodiment.

FIG. 2 is an end view of the grasping pliers.

FIG. 3 is a section view of the grasping pliers illustrating the operation of the pressure adjustment control.

FIG. 4 is a plan view of the grasping pliers of FIG. 1 grasping an object.

FIG. 5 illustrates the change in position for changing the range of the grasping distance.

FIG. 6 illustrates in accordance with another embodiment of the invention, a cylinder for restricting the grasping range.

FIG. 7 is a section view of the control for limiting the grasping range.

### DESCRIPTION OF THE PREFERRED EMBODIMENT

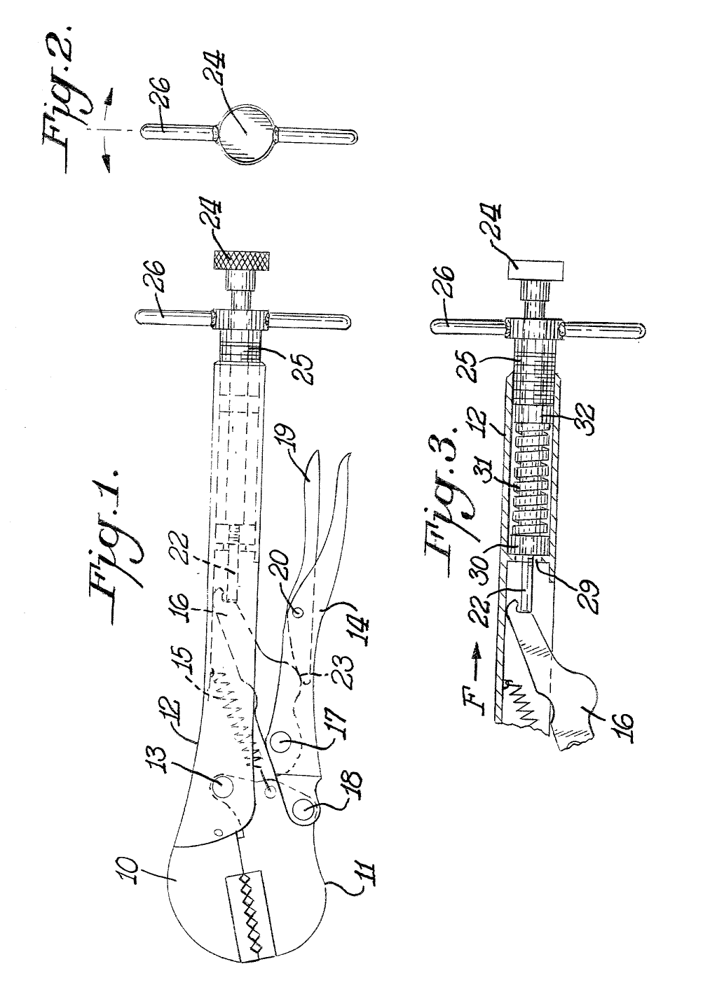

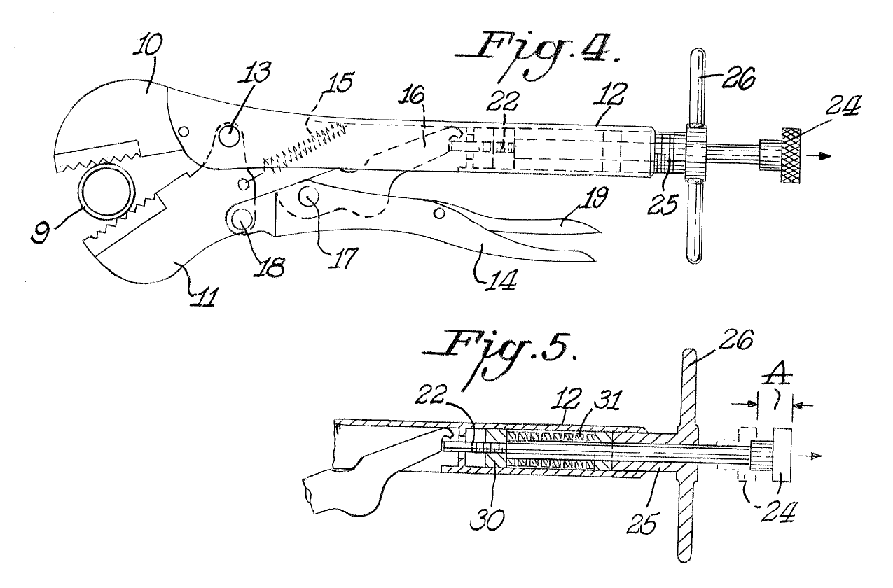

Referring now to FIGS. 1, 2, and 3, a variable grip locking pliers in accordance with a preferred embodiment of the invention is illustrated. FIG. 2 is an end view and FIG. 3 a section view of the pliers of FIG. 1. Conventional grasping jaws 10 and 11 are pivoted together at 13. A lower handle 14 is pivotally connected to the lower jaw 11 at pivot 18. The jaws are biased towards an open condition with a spring 15 connected to the lower jaw 11 and an upper handle 12 extending rearward from the upper jaw 10 when the handles are moved away from each other. A toggle 16 is pivotally connected to the lower handle 14, and extends into a slot in upper handle 12. As is conventional in locking type pliers, as the toggle 16 moves, due to the positioning of control rod 22, the location of pivot 17 moves. As the position of pivot 17 moves rearward, the grasping distance between jaws 10 and 11 is increased. A release lever 19 pivots with respect to lower handle 19 at pivot 20 engaging camming surface 23, pushing pivot point 17 rearward to break the lock between jaws 10 and 11, releasing jaws 10, 11 from their grip as is conventional with grasping type pliers.

The foregoing embodiment of the invention establishes a nominal grasping range for jaws 10 and 11 by setting the position of control rod 22 in stop 30. A pressure adjustment control 25 is shown threaded into the handle 12. The pressure adjustment control 25 has a bore through which control rod 22 extends; so that the end of control rod 22 engages the end of the toggle 16 for establishing a range of grasping distances for jaws 10 and 11.

Stop 30 is fixed to the rod 22 and its forward movement is limited by the wall 29 through which the end of rod 22 extends. During grasping, forces exerted by the jaws 10 and 11 are exerted on toggle 16. The force F moves the rod 22 and stop 30 rearward, against the force of spring 31. The remaining end of spring 31 abuts a washer 32 which in turn abuts the end of pressure adjustment control 25.

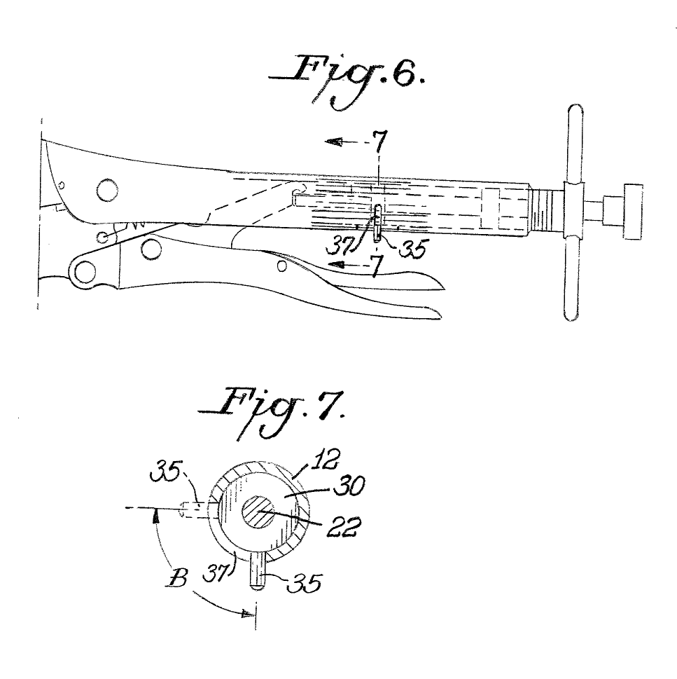

The nominal grasping distance established on jaws 10 and 11 is effected by rotation of knurled end 24 of control rod 22. Control rod 22 passes through a bore in the pressure adjustment control 25, and is threaded into stop 30. Due to the force between spring 31 and stop 30 and the friction between stop 30 and wall 29, stop 30 remains essentially stationary and does not rotate as the rod 22 is rotated to position it along the length of handle 12. During grasping of an object, as will be evident with respect to FIGS. 4 and 5, following the setting of the nominal distance between the jaws 10 and 11, toggle 16 moves rearward in the event that the item being grasped is larger than the nominal distance set between jaws 10 and 11. This results from the compression of spring 31 by stop 30, until the spring 31 is fully compressed. In this way, a grasping range is established, proportional to the distance from the initial position of stop 29, to a fully compressed spring 31. Compressed spring 31 will establish a nominal grasping force on the jaws 10 and 11 during grasping of an object. The grasping force is essentially the same and does not vary significantly until spring 31 is in its fully compressed state thereby limiting the force between the jaws 10, 11 and the object being grasped. The nominal grasping force for jaws 10, 11 can be changed by threading the pressure adjustment control 25 into and out of the handle 12 by rotating handle 26. Pressure adjustment control 25 moves washer 32 and spring 31 along the length of the handle 12 forcing stop 30 forward.

FIGS. 4 and 5 illustrate more completely the operation of the device when grasping an object 9. Initially, as shown in FIG. 1, when jaws 10 and 11 are opened, the stopper 30 comes to rest on wall 29. The jaws are opened at a distance large enough to grasp an item 9 as is shown in FIGS. 4 and 5 by threading control rod 22 so that the toggle link is positioned to obtain a nominal setting for the distance between jaws 10, 11.

As FIGS. 4 and 5 demonstrate, the closure of the handles 12 and 14 results in grasping of the object 9 and compression of the spring 31. The amount of compression of spring 31 will depend on the size of the object being gripped vis-a-vis the initial jaw opening distance. Pressure adjustment control 25 sets the amount of grasping force established by spring 31. Thus, a range of grasping forces can be established for each setting of the pressure adjustment control 25 by changing the length of compression spring 31 from its nominal length to its fully compressed length.

When grasping an object 9, a range of grasping distances is established by the ability of the rod 22 to move against compression spring 31. As a larger grasping distance is needed for larger objects, the knurled end 24 is rotated counterclockwise to move rod 22 rearward. The result is a new range in which jaws 10 and 11 can be used to grasp an object 9 of a larger dimension.

FIGS. 6 and 7 represent yet another embodiment of the invention, in which the pliers can be used in a conventional mode of operation eliminating the effects of the pressure adjustment control 25. In this mode of operation, stop 30 is shown having a pin 35 extending through the slot in the underside of handle 12 fixing the position of the stop 30 in the handle 12. By rotating the stop 30 using the pin 35, so that pin 35 is captivated in a slot 37 in handle 12, the rod 22 is held in position and cannot move rearward during grasping of an object. Threading rod 22 using the knurled end 24, provides different grasping distances between jaws 10 and 11 as in prior art grip locking pliers.

The foregoing disclosure includes all the information deemed essential to enable those skilled in the art to practice the claimed invention. Because the cited applications may provide further useful information, these cited materials are hereby incorporated by reference in their entirety. The foregoing description of the invention illustrates and describes the present invention. Additionally, the disclosure shows and describes only the preferred embodiments of the invention but, as mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

What is claimed is:

1. A self-adjusting grasping pliers comprising:
an upper grasping jaw;
a lower grasping jaw pivotally connected to said upper grasping jaw;
a first handle extending from said upper grasping jaw rearward thereof;
a second handle pivotally connected to said lower grasping jaw, extending rearward thereof below said first handle;
a biasing spring for urging said jaws apart;
a toggle member pivotally connected at one end to said second handle extending upwards into a longitudinal slot in said first handle;
a pressure adjustment control connected to one end of said first handle, extending into said handle a distance which is adjustable; and
a grasping size control rod extending through said pressure adjustment control engaging one end of said toggle member; said control rod having a spring between a stop threaded to said control rod and said pressure adjustment control, whereby said pressure adjustment control is adjusted to compress said spring to establish a nominal grasping force for said jaws.

2. The self adjusting grasping pliers according to claim 1 wherein a pin is provided on said stop for engaging said handle for selectively inhibiting movement of said control rod during grasping by said first and second jaws.

3. The self adjusting grasping pliers according to claim 2 wherein said stop includes a laterally extending pin which engages a second slot in said handle to limit rearward movement of said control rod in said handle.

4. The self adjusting grasping pliers according to claim 1 wherein said pressure adjustment control is connected to the end of said handle by threads permitting said pressure adjustment control to extend into said handle with varying lengths.

5. The self adjusting grasping pliers according to claim 1 further comprising an unlocking lever connected to said second handle for releasing said jaws from grasping an object.

6. A self adjusting grasping pliers comprising:
an upper grasping jaw;
a lower grasping jaw pivotally connected to said upper grasping jaw;
a first handle extending from said upper grasping jaw rearward thereof;
a second handle pivotally connected to said lower grasping jaw, extending rearward thereof below said first handle;
a biasing spring for urging said jaws apart;
a toggle member pivotally connected at one end to said second handle, extending upwards into a longitudinal slot in said handle;
a control rod extending through said first handle having one end engaging said toggle, said control rod having a stop adjacent said one end bearing against one end of a spring extending rearward towards said handle distal end; and
a pressure adjustment control having one end bearing against a remaining end of said spring, said pressure adjustment control establishing a nominal grasping force for said jaws.

7. The self adjusting grasping pliers according to claim 6 wherein said pressure adjustment control extends through a distal end of said handle and abuts said spring.
